(19) United States
(12) Patent Application Publication
(10) Pub. No.: US 2025/0333114 A1
(43) Pub. Date: Oct. 30, 2025

(54) VEHICLE FRONT PART STRUCTURE

(71) Applicant: TOYOTA JIDOSHA KABUSHIKI KAISHA, Toyota-shi (JP)

(72) Inventor: Koji SAEKI, Okazaki-shi (JP)

(73) Assignee: TOYOTA JIDOSHA KABUSHIKI KAISHA, Toyota-shi (JP)

(21) Appl. No.: 19/013,181

(22) Filed: Jan. 8, 2025

(30) Foreign Application Priority Data
Apr. 24, 2024 (JP) 2024-070711

(51) Int. Cl. B62D 25/08; B62D 25/10

(52) U.S. Cl. CPC B62D 25/084; B62D 25/10

(57) ABSTRACT

The vehicle front part structure includes a pair of front side members extending along the vehicle front-rear direction on both sides in the vehicle width direction of the vehicle front portion, a radiator disposed between the pair of front side members and arranged in an inclined posture such that an end portion on the vehicle lower side protrudes toward the vehicle front side from an end portion on the vehicle upper side, a support portion provided at an intermediate portion in the vehicle front-rear direction of the pair of front side members and on a vehicle rear side of the radiator, respectively, and supporting the radiator so as to be rotatable in the vehicle width direction as an axial direction, and a fixing portion for fixing a portion on the vehicle lower side of the radiator to the vehicle body.

### CROSS-REFERENCE TO RELATED APPLICATION

This application claims priority to Japanese Patent Application No. 2024-070711 filed on Apr. 24, 2024, incorporated herein by reference in its entirety.

### BACKGROUND

### 1. Technical Field

The present disclosure relates to a vehicle front part structure.

### 2. Description of Related Art

Japanese Unexamined Patent Application Publication No. 2002-362171 (JP 2002-362171 A) discloses a radiator mounting structure in which front end portions of side members are caused to support a lower end of a radiator at a vehicle front part and a member on a vehicle body side is caused to rotatably support an upper end portion of the radiator. The technology described in JP 2002-362171 A adopts a configuration in which the lower end portion of the radiator is supported by the front end portions of the side members. Therefore, if an impact load is input from a vehicle front side, the impact load is input in the axial direction of the side members and is also input as a rear load to the lower end portion of the radiator via a guide mechanism.

### SUMMARY

In recent years, obliquely mounting a radiator in order to reduce the height of a hood at a vehicle front part has been considered from the viewpoint of improving aerodynamic performance of a vehicle. On the other hand, although impact is absorbed by axially compressing front side members at the time of front collision, a radiator lower end portion of an obliquely mounted radiator projects forward, and the radiator is likely to be affected by an impact caused by the collision.

Here, according to the technology of JP 2002-362171 A, the lower end portion of the radiator is supported by the front end portions of the front side members, and the radiator may be damaged at the time of front collision. Also, there may be a case where a rotation mechanism is attached to an upper surface of the radiator as in the technology of JP 2002-362171 A. In this case, an upward pushing load may act on the rotation mechanism due to a load input to the lower end portion of the radiator, and the radiator and the rotation mechanism may be damaged.

The present disclosure has been made in view of the above circumstances, and an object of the present disclosure is to obtain a vehicle front part structure capable of suppressing damage on a heat exchanger at the time of front collision of a vehicle in a structure in which the heat exchanger is obliquely mounted on a vehicle front part.

A vehicle front part structure according to the present disclosure described in claim 1 includes:
a pair of front side members that extend along a vehicle front-rear direction on both sides of a vehicle front part in a vehicle width direction;
a heat exchanger that is disposed between the pair of front side members, the heat exchanger being disposed in an inclined posture in which an end portion on a vehicle lower side projects closer to a vehicle front side than an end portion on a vehicle upper side;
support portions each provided at an intermediate portion of the pair of front side members in the vehicle front-rear direction and on a vehicle rear side of the heat exchanger, the support portions supporting the heat exchanger such that the heat exchanger is rotatable about the vehicle width direction as an axial direction; and
a fixing portion that fixes a portion of the heat exchanger on the vehicle lower side to a vehicle body.

According to the vehicle front part structure of the present disclosure described in claim 1, the heat exchanger is disposed between the pair of front side members. Also, the heat exchanger is disposed in the inclined posture in which the end portion on the vehicle lower side projects closer to the vehicle front side than the end portion on the vehicle upper side. Therefore, it is possible to reduce the height of the hood at the vehicle front part and to improve aerodynamic performance.

Here, the vehicle front part structure includes the support portions provided at the intermediate portion of the front side members in the vehicle front-rear direction to support the heat exchanger such that the heat exchanger is rotatable about the vehicle width direction as the axial direction, and includes the fixing portion provided to fix the portion of the heat exchanger on the vehicle lower side to the vehicle body. Therefore, when a colliding object comes into contact with the vehicle body in the middle of impact absorption through axial compression of the front side members at the time of front collision, fixation of the portion of the heat exchanger on the vehicle lower side achieved by the fixing portion is released, and the heat exchanger rotates. It is thus possible to cause a load to be imparted on the heat exchanger to escape.

Furthermore, since the vehicle front part structure is provided with the support portions on the vehicle rear side of the heat exchanger, an upward pushing load acting on the support portion is suppressed by a load input to the heat exchanger. Also, damage on the support portions in the middle of impact absorption through axial compression of the front side members is avoided.

In this manner, the vehicle front part structure can suppress damage on a radiator at the time of front collision of the vehicle in the structure in which the heat exchanger is obliquely mounted on the vehicle front part.

According to the vehicle front part structure of the present disclosure described in claim 2, in the configuration described in claim 1,
the fixing portion includes a protruding portion that projects from a side of the vehicle body and a fitting recessed portion that is provided on a side of the heat exchanger, the protruding portion being fitted into the fitting recessed portion.

In the vehicle front part structure according to the present disclosure described in claim 2, the protruding portion that projects from the side of the vehicle body is fitted into the fitting recessed portion provided on the side of the heat exchanger in the fixing portion. Therefore, when a colliding object comes into contact with the vehicle body in the middle of impact absorption through axial compression of the front side members at the time of front collision, the protruding portion projecting from the side of the vehicle body is broken, and fixation of the portion of the heat exchanger on the vehicle lower side achieved by the fixing portion can be thereby released.

According to the vehicle front part structure of the present disclosure described in claim 3, in the configuration described in claim 1, the fixing portion further includes an elastic portion that is interposed between the protruding portion and the fitting recessed portion.

In the vehicle front part structure according to the present disclosure described in claim 3, the fixing portion includes the elastic portion that is interposed between the protruding portion and the fitting recessed portion. Therefore, it is possible to absorb vibration of the vehicle body at the time of traveling by the elastic portion and suppress transmission thereof to the heat exchanger.

According to the vehicle front part structure of the present disclosure described in claim 4,
in the configuration described in claim 1, a portion of the heat exchanger on the vehicle lower side is fixed to a lower absorber that extends in the vehicle width direction as the vehicle body, and at least a part of a side surface of the lower absorber on the vehicle front side is disposed closer to the vehicle front side than the pair of front side members.

In the vehicle front part structure according to the present disclosure described in claim 4, the portion of the heat exchanger on the vehicle lower side is fixed to the lower absorber that extends in the vehicle width direction as the vehicle body. At least a part of the side surface of the lower absorber on the vehicle front side is disposed closer to the vehicle front side than the pair of front side members. Therefore, a collision load is transmitted to the lower absorber in an initial stage at the time of front collision, and it is possible to quickly release the part of the heat exchanger on the vehicle lower side by the fixing portion.

According to the vehicle front part structure of the present disclosure described in claim 5, in the configuration described in claim 1, the support portions are configured to support an end portion of the heat exchanger on the vehicle upper side.

In the vehicle front part structure according to the present disclosure described in claim 5, the support portion is configured to support the end portion of the heat exchanger on the vehicle upper side. Therefore, it is possible to further reduce the height of a radiator in a power unit room as compared with a case where an intermediate portion of the radiator in the vehicle up-down direction is supported by the support portions. As a result, it is possible to more effectively reduce the height of the hood at the vehicle front part.

In the configuration described in claim 1, the vehicle front part structure according to the present disclosure described in claim 6 further includes:
a hood that covers a power unit room at the vehicle front part from the vehicle upper side; and an accommodating portion with a box shape that is provided on the vehicle upper side of the heat exchanger and on the vehicle lower side of the hood,
the support portions are configured to support an intermediate portion of the heat exchanger in a vehicle up-down direction, and
the heat exchanger is configured such that once the heat exchanger rotates in response to release of fixation achieved by the fixing portion, a portion of the heat exchanger on the vehicle upper side abuts the accommodating portion.

In the vehicle front part structure according to the present disclosure described in claim 6, the support portions are configured to support the intermediate portion of the heat exchanger in the vehicle up-down direction. Also, once the fixation of the portion of the heat exchanger on the vehicle lower side achieved by the fixing portion is released at the time of front collision, the portion on the vehicle upper side moves on the vehicle front side due to rotation of the heat exchanger and abuts the accommodating portion with the box shape provided on the vehicle lower side of the hood. In this manner, it is possible to stop the rotation of the heat exchanger after the portion of the heat exchanger on the vehicle lower side is caused to retract on the vehicle rear side at the time of the front collision. Moreover, in a case where there is a further input of collision load, it is possible to absorb a part of the collision load by the portion of the heat exchanger on the vehicle upper side crushing the accommodating portion.

As described above, the vehicle front part structure according to the present disclosure can suppress damage on the heat exchanger at the time of front collision of the vehicle in the structure in which the heat exchanger is obliquely mounted on the vehicle front part.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a left side view schematically illustrating an example of a vehicle front part structure according to a first embodiment;

FIG. 2 is a front view schematically illustrating an example of the vehicle front part structure of FIG. 1;

FIG. 3 is a left side cross-sectional view schematically showing the vicinity of the fixing portion, partially cut along line 3-3 of FIG. 2; and

FIG. 4 is a left side view schematically illustrating an example of a vehicle front part structure according to the second embodiment.

### DETAILED DESCRIPTION OF EMBODIMENTS

### First Embodiment

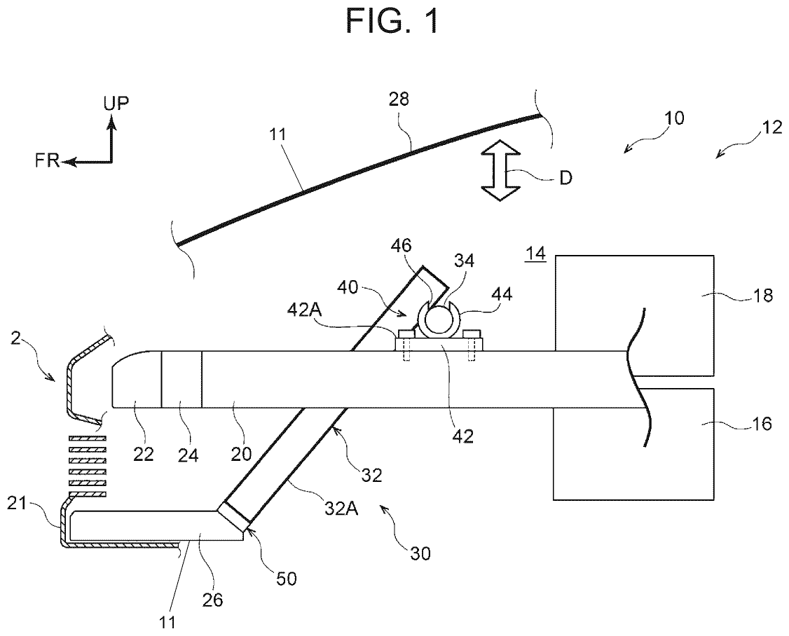

Hereinafter, a first embodiment of the present disclosure will be described with reference to FIGS. 1 to 3. Note that an arrow FR appropriately shown in the drawings indicates a front side in the vehicle front-rear direction, and an arrow UP indicates an upper side in the vehicle up-down direction. The arrow IN indicates the vehicle-width-direction inner side. Hereinafter, in the case of simply describing the front-rear direction, the up-down direction, and the left-right direction, the front-rear direction of the vehicle front-rear direction, the up-down direction of the vehicle up-down direction, and the left-right direction of the vehicle (the vehicle width direction) are shown unless otherwise specified.

In addition, unless otherwise specified in the specification, each element is not limited to one, and a plurality of elements may be present. In addition, in the drawings, substantially the same elements are denoted by the same reference numerals, and redundant description in the specification is omitted.

### Configuration of Vehicle Front Part Structure

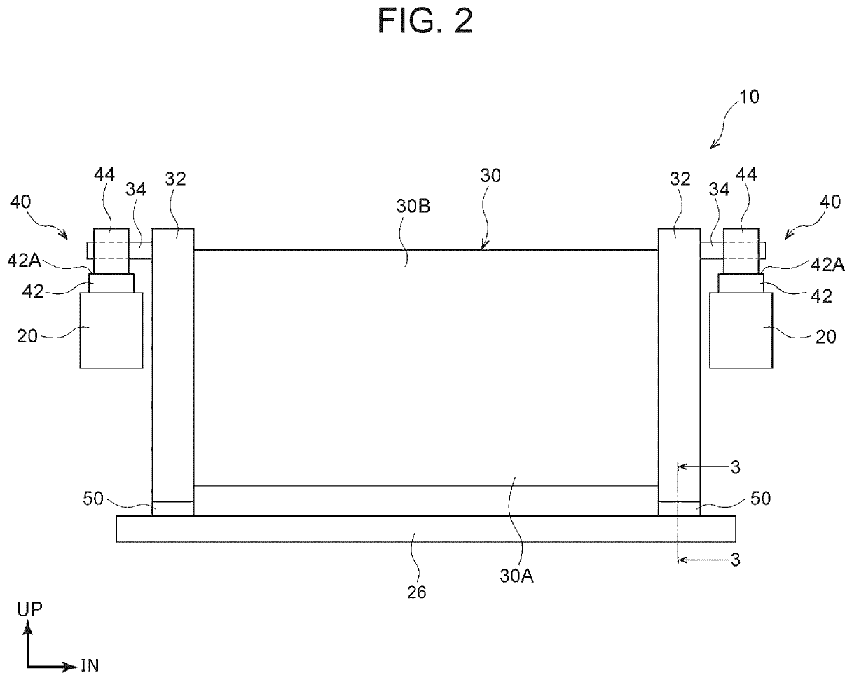

First, a configuration of the vehicle front part structure 10 will be described as an example of the vehicle front part structure according to the first embodiment of the present disclosure. FIG. 1 is a side view schematically showing an example of a vehicle front part structure 10, and FIG. 2 is a front view schematically showing an example of the vehicle front part structure 10 of FIG. 1.

FIG. 1 and FIG. 2 schematically show a vehicle front part structure 10 of a vehicle 12. In the present embodiment, the vehicle 12 is, for example, a battery-type battery electric vehicle including a battery and a motor as a drive source.

As shown in FIG. 1, a power unit room 14 is disposed on the vehicle rear side of the bumper 2 at the front portion of the vehicle 12. A power unit 16 is housed inside the power unit room 14. In the present embodiment, since the vehicle 12 is a battery electric vehicle, the power unit 16 is a drive unit and includes an electric motor that generates a driving force for rotating drive wheels (not shown) of the vehicle. A battery stack 18 as a battery is disposed directly above the power unit 16. The battery stack 18 is formed by stacking a plurality of battery cells (not shown) in a predetermined direction. Each battery cell stores electric power for rotating the electric motor of the power unit 16.

As illustrated in FIGS. 1 and 2, the vehicle front part structure 10 includes a pair of left and right front side members 20 that are front skeletal members of the vehicle body 11 of the vehicle 12 and are disposed on both sides in the vehicle width direction of the vehicle front portion. The front side member 20 is a vehicle body skeleton member, and extends in the vehicle front-rear direction, and is formed in, for example, a closed cross-sectional structure. The front end portion of the front side member 20 is connected to a front bumper reinforcement 22 (hereinafter referred to as “bumper RF22”) disposed along the vehicle width-direction. In the present embodiment, the front side member 20 includes a crash box 24 as an energy absorbing member at a front end portion connected to the bumper RF22. The front side member 20 is fixed coaxially with respect to the crash box 24 so that a collision load from the front of the vehicle body 11 is reduced. Although the crash box 24 is described as a separate component from the bumper RF22 in the present embodiment, the crash box may be integrated with the crash box.

Further, a hood 28 constituting an outer plate of the vehicle body 11 is disposed on an upper side of the pair of left and right front side members 20. The hood 28 is a plate-shaped member having a substantially rectangular shape in plan view, and is configured to cover the power unit room 14 from the vehicle upper side. As an example, the hood 28 is configured to be able to open and close an opening of the power unit room 14 by supporting an end portion on the vehicle rear side with a hinge mechanism (not shown).

Inside the power unit room 14, a radiator 30 as a heat exchanger is disposed on the vehicle front side of the power unit 16. The radiator 30 is disposed between the pair of front side members 20. As illustrated in FIG. 1, the radiator 30 of the present embodiment is mounted in an inclined attitude such that an end portion 30A on the vehicle lower side protrudes toward the vehicle front side from an end portion 30B on the vehicle upper side. Although not shown, a cylindrical fan shroud, an electric fan, and the like for guiding the air introduced from the radiator 30 to the vehicle rear side are disposed behind the radiator 30.

The radiator 30 is, for example, a structure that is formed in a substantially rectangular frame shape when viewed in the vehicle front-rear direction and is flat in the vehicle front-rear direction, and is provided with a refrigerant pipe (not shown) that meanders to reciprocate a plurality of times in the vehicle width direction as an example. A plurality of fins (not shown) are attached to the refrigerant pipe, and the atmosphere introduced into the inside of the power unit room 14 passes between the fins through a front grille (not shown) while the vehicle 12 is traveling to cool the refrigerant inside the refrigerant pipe. The refrigerant pipe circulates with a flow path inside the battery stack 18, and the refrigerant pumped by a pump (not shown) circulates inside the battery stack 18 through the refrigerant pipe to exchange heat. Accordingly, the battery stack 18 is cooled. The refrigerant pipe may be configured to circulate with a flow path inside the power unit 16.

As shown in FIG. 2, the radiator 30 is supported by the vehicle body 11 by a radiator support 32 fixed to both end portions in the vehicle width direction. The radiator support 32 is a hollow member having a horizontal cross section formed in a substantially rectangular shape, and is constituted by a side member elongated in the vehicle vertical direction. The radiator support 32 may further include an upper support member (not shown) and a lower support member (not shown) each extending in the vehicle width direction in the vertical direction of the radiator 30. In the present embodiment, the radiator support 32 is supported by a front side member 20 constituting a part of the vehicle body 11 and a cross member 26 constituting a part of the vehicle body 11.

As an example, an end portion of each radiator support 32, which is a side member, on the outer side in the vehicle width direction is supported by a front side member 20 as a skeleton frame of the vehicle body 11 of the vehicle 12. Here, the support portion 40 provided in the front side member 20 is disposed on the vehicle rear side of the radiator 30 when viewed from the side in the vehicle width direction.

Specifically, the radiator supports 32 include cylindrical rotating shafts 34 that project outward from the vehicle rear side surface 32A in the vehicle widthwise direction. As shown in FIG. 2, the rotation shaft 34 is provided on the vehicle upper end portion 30B. The vehicle upper end portion 30B of the radiator 30 is, for example, approximately one-fifth of the vehicle vertical dimension of the upper side. As an example, the rotation shaft 34 is made of resin.

The rotation shaft 34 may be inserted into a shaft hole (not shown) provided on a side surface 32A of the radiator support 32, for example, and fixed by a screw or the like. The rotation shaft 34 may be provided with a flange at one end of the rotation shaft 34, and the flange may be attached to the side surface 32A by a screw or the like. As the fixing method, a known technique can be used. As in the present embodiment, it is not essential to fix one axial end of the rotation shaft 34 to the vehicle-rear side surface 32A of the radiator support 32. For example, the rotation shaft 34 may be configured to extend from a side surface of the radiator support 32 outside in the vehicle width direction. In this case, the rotation shaft may be bent in a crank shape, one end in the extending direction may be fixed to the radiator support 32 side, and the other end in the extending direction may be supported by a support portion 40, which will be described later, of the front side member.

As shown in FIG. 1, the rotation shaft 34 is rotatably supported in the vehicle width direction as the axial direction by a support portion 40 provided at an intermediate portion of the pair of left and right front side members 20 in the vehicle front-rear direction in the power unit room 14.

As shown in FIGS. 1 and 2, the support portion 40 includes a support base 42 and a bearing portion 44. The support base 42 and the bearing portion 44 may be integrally formed or may be separately formed. The support base 42 is formed in a substantially rectangular shape when viewed from the up-down direction, and is fastened to the upper surface of the front side member 20 by, for example, a bolt or the like at two places on the vehicle front side and the vehicle rear side of the bearing portion 44 as an example.

The bearing portion 44 has a substantially cylindrical shape, and is disposed on the upper surface 42A of the support base 42 so that the axial direction thereof is the vehicle-width direction. The bearing portion 44 rotatably supports the rotation shaft 34 with the vehicle width direction as an axis. That is, the support portion 40 supports the rotation shaft 34 from the vehicle width direction side. Further, as shown in FIG. 1, the bearing portion 44 has an opening portion 46 in which a part of the cylinder is cut out at an upper portion in the vehicle vertical direction. The opening portion 46 functions as a detachment structure for detaching the rotation shaft 34 from the bearing portion 44 after the rotation shaft 34, i.e., the radiator 30, is rotated. It should be noted that the opening portion 46 is not necessarily provided in the bearing portion 44, and the opening portion 46 may be omitted.

As shown in FIGS. 1 and 2, the vehicle front part structure 10 includes a cross member 26 that is disposed on the front side of the radiator 30 and extends in the vehicle width direction. In the present embodiment, the cross member 26 is, for example, a lower absorber. The lower absorber has a function of absorbing and reducing the impact energy when the lower absorber collides with a pedestrian in front, and is formed of a foamed resin material, a plastic resin material, or the like. As an example, a portion of the cross member 26 on the front side of the vehicle is fixed to the bottom of the front bumper cover 21 by fixing means such as bolt fastening. In this state, at least a part of the side surface of the cross member 26 on the vehicle front side is disposed closer to the vehicle front side than the pair of left and right front side members 20.

In the present embodiment, an end portion 30A, which is a portion of the radiator 30 below the vehicle, is fixed to the cross member 26 as the vehicle body 11 via the fixing portion 50.

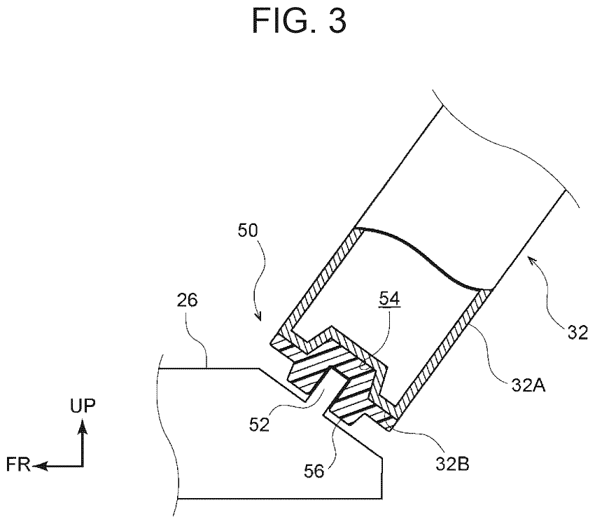

FIG. 3 is a left side view schematically showing the vicinity of the fixing portion 50. As shown in FIG. 3, as an example, the fixing portion 50 includes a protruding portion 52 protruding from the cross member 26 side, a fitting recessed portion 54 provided on the radiator 30 side, and an elastic portion 56 disposed on the inner surface of the fitting recessed portion 54.

The protruding portion 52 is provided at an end portion of the cross member 26 on the vehicle rear side and protrudes obliquely toward the vehicle rear side and the vehicle upper side. The protruding portion 52 may be formed integrally with the cross member 26 or may be formed separately.

The fitting recessed portion 54 is provided on the vehicle-lower side surface 32B of the radiator support 32, and is formed as a cylindrical hole recessed in a concave shape. The fitting recessed portion 54 may be formed integrally with the radiator support 32 or may be formed separately. An end portion of the radiator 30 on the vehicle lower side is fixed to the cross member 26 by inserting and fitting the protruding portion 52 protruding from the cross member 26 side into the fitting recessed portion 54.

Here, as shown in FIG. 3, since the portion of the cross member 26 on the vehicle front side is located closer to the vehicle front side than the radiator support 32, a load is applied to the cross member 26 before the radiator support 32 at the time of the front collision. When a load from the vehicle front side is applied to the cross member 26, the protruding portion 52 is pressed to the vehicle rear side together with the cross member 26. In the present embodiment, the strength of the protruding portion 52 is set to be such a degree that it is broken when the protruding portion 52 is pressed toward the vehicle rear side by a load at the time of a front collision. Therefore, the fixing of the cross member 26 and the radiator support 32 by the fixing portion 50 is released at the time of a forward collision.

Here, an elastic portion 56 made of rubber or the like is provided on the inner surface of the fitting recessed portion 54. Therefore, in a state in which the protruding portion 52 is fitted into the fitting recessed portion 54, the elastic portion 56 is interposed between the protruding portion 52 and the fitting recessed portion 54. As a result, vibration during traveling transmitted through the cross member 26 is absorbed by the elastic portion 56. As a result, the vibration during traveling is suppressed from being transmitted to the radiator 30 side, and consumption of the fixing portion 50, generation of abnormal noise, and the like are suppressed.

### Action and Effect

Next, the operation and effects of the vehicle front part structure 10 according to the first embodiment will be described.

In the vehicle front part structure 10, a radiator 30 as a heat exchanger is disposed between a pair of front side members 20. Further, the radiator 30 is disposed in an inclined posture such that the vehicle lower end portion 30A protrudes toward the vehicle front side relative to the vehicle upper end portion 30B. Therefore, the height of the hood 28 at the front portion of the vehicle can be suppressed, and the aerodynamic performance can be improved. Further, as indicated by an arrow D in FIG. 1, an empty space for pedestrian protection can be easily secured between the vehicle body 11 and the radiator 30.

Here, in the vehicle front part structure 10, a support portion 40 that rotatably supports the radiator 30 is provided at an intermediate portion of the front side member 20 in the vehicle front-rear direction. Further, a fixing portion 50 that fixes a portion of the radiator 30 on the vehicle lower side to the vehicle body 11 is provided. In some cases, a collision object comes into contact with the vehicle body 11 in the middle of shock absorption in axial compression of the front side member 20 during a forward collision. In this case, the fixing of the portion of the radiator 30 on the vehicle lower side by the fixing portion 50 is released, and the radiator 30 rotates counterclockwise in FIG. 1. As a result, the end portion 30A of the radiator 30 on the vehicle lower side is retracted toward the vehicle rear side, and the load applied to the radiator 30 can be released.

Further, in the vehicle front part structure 10, since the support portion 40 is provided on the vehicle rear side of the radiator 30, the load to be pushed upward by the load input to the radiator 30 is suppressed from acting on the support portion 40. In addition, the support portion 40 is suppressed from being damaged during the shock absorption in the axial compression of the front side member 20.

In this way, in the vehicle front part structure 10 according to the first embodiment, in the structure in which the radiator 30 is mounted obliquely on the vehicle front, it is possible to suppress the damage of the radiator 30 at the time of a front collision of the vehicle 12.

Further, in the first embodiment, in the fixing portion 50, the protruding portion 52 protruding from the cross member 26 side constituting the vehicle body 11 is fitted into the fitting recessed portion 54 provided on the radiator 30 side. In some cases, a collision object comes into contact with the cross member 26 in the middle of shock absorption in axial compression of the front side member 20 at the time of a forward collision. In this case, the protruding portion 52 protruding from the cross member 26 side is destroyed, and the fixing of the portion of the radiator 30 on the vehicle lower side by the fixing portion 50 can be released.

Further, the fixing portion 50 has an elastic portion 56 interposed between the protruding portion 52 and the fitting recessed portion 54. Therefore, vibration of the vehicle body 11 during traveling can be absorbed by the elastic portion 56, and can be suppressed from being transmitted to the radiator 30.

Further, the cross member 26 is a lower absorber extending in the vehicle width direction. Therefore, a portion of the radiator 30 on the vehicle lower side is fixed to the lower absorber. Therefore, at least a part of the side surface of the cross member 26 on the vehicle front side is disposed closer to the vehicle front side than the pair of left and right front side members 20. As a result, the collision load is transmitted to the cross member 26 in the initial stage of the forward collision, and the radiator 30 can be quickly released from the lower part of the vehicle by the fixing portion 50.

In addition, in the first embodiment, the support portion 40 is configured to support the vehicle upper end portion 30B of the radiator 30. Therefore, the height of the radiator 30 in the power unit room 14 can be further suppressed as compared with the case where the intermediate portion of the radiator 30 in the vehicle up-down direction is supported by the support portion 40. As a result, it is possible to more effectively reduce the height of the hood at the vehicle front part.

Further, in the vehicle front part structure 10 according to the first embodiment, the support portion 40 includes a bearing portion 44 that supports the rotation shaft 34 of the radiator 30, and the opening portion 46 provided at the upper portion of the bearing portion 44 in the vehicle vertical direction constitutes a falling-off structure. At the time of a forward collision, the radiator 30 rotates due to the rotation of the rotation shaft 34 supported by the bearing portion 44, and a further collision load may be input to the radiator 30. In this case, the radiator 30 can be detached by the rotation shaft 34 being detached from the opening portion 46.

### Second Embodiment

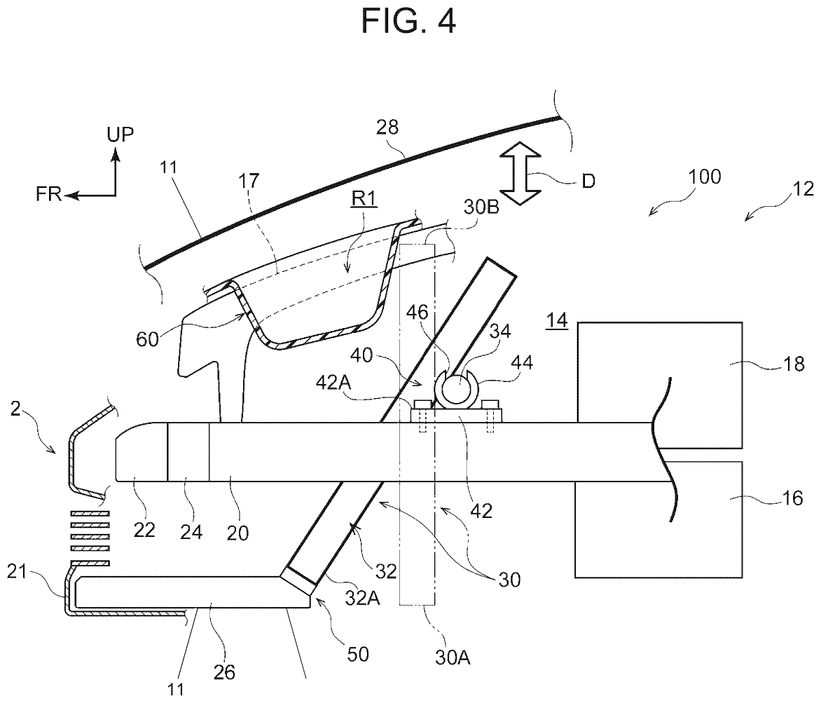

Hereinafter, the vehicle front part structure 100 according to the second embodiment will be described with reference to FIG. 4. The same components as those in the first embodiment are denoted by the same reference numerals, and the description thereof will be omitted.

As shown in FIG. 4, in the vehicle front part structure 100 according to the second embodiment, the box-shaped accommodating portion 60 is provided on the vehicle lower side of the hood 28 that covers the power unit room 14 from the vehicle upper side. Further, the support portion 40 is configured to support an intermediate portion of the radiator 30 as a heat exchanger in the vehicle vertical direction. The other configuration is the same as the vehicle front part structure 10 according to the first embodiment. The intermediate portion of the radiator 30 in the vehicle up-down direction is, for example, a range that occupies about ⅕ of the dimension in the vehicle up-down direction (the end portion 30B on the vehicle upper side) and a range that occupies about ⅕ of the dimension in the vehicle up-down direction (the end portion 30A on the vehicle lower side).

The accommodating portion 60 is a box-shaped member made of a resin material or the like, and has, for example, a bathtub shape having an opening portion opened to the vehicle upper side. The accommodating portion 60 forms a luggage compartment R1 of the front portion of the vehicle with the hood 28. The accommodating portion 60 is supported by, for example, an apron upper member 17 in which an end portion on the vehicle width direction outer side is disposed on the vehicle width direction outer side and the vehicle upper side of the front side member 20. The apron upper member 17 is a skeleton member that constitutes the upper side of the front portion of the vehicle body 11. The apron upper member 17 extends along the front side member 20 in the vehicle front-rear direction, and a portion on the vehicle front side is supported by the front side member 20 from the lower side. Further, a rear end portion of the apron upper member 17 is coupled to a front pillar (not shown). Here, the apron upper member 17 is formed separately from the front side member 20, but may be integrally formed.

The accommodating portion 60 is disposed on the upper side of the radiator 30. As shown by the solid line position in FIG. 4, when the radiator 30 is inclined, the end portion of the accommodating portion 60 on the vehicle rear side is disposed on the front side of the end portion 30B on the vehicle upper side of the radiator 30. An end portion of the accommodating portion 60 on the vehicle rear side is provided with a space between the end portion 30B of the radiator 30 and the vehicle front-rear direction. When the collision body collides with the vehicle body 11 at the time of the front collision and the fixing of the portion of the radiator 30 on the vehicle lower side by the fixing portion 50 is released, the portion of the radiator 30 on the vehicle upper side rotates counterclockwise in FIG. 4. Then, as shown by the two-dot chain line position in FIG. 4, the portion of the radiator 30 on the vehicle upper side moves to the vehicle front side and abuts on the end portion of the accommodating portion 60 on the vehicle rear side.

### Action and Effect

Since the vehicle front part structure 100 according to the second embodiment basically follows the configuration of the vehicle front part structure 10 according to the first embodiment, the same operation and effects can be obtained.

On the other hand, in the vehicle front part structure 100 according to the second embodiment, the support portion 40 is configured to support an intermediate portion of the radiator 30 in the vehicle vertical direction. Then, when the fixing of the vehicle lower side portion of the radiator 30 by the fixing portion 50 is released at the time of the front collision, the vehicle upper side portion moves toward the vehicle front side by the rotation of the radiator 30, and comes into contact with the box-shaped accommodating portion 60 provided on the vehicle lower side of the hood 28. Accordingly, it is possible to stop the rotation of the radiator 30 after the vehicle lower portion of the radiator 30 is retracted toward the vehicle rear side at the time of the front collision. Further, when there is an input of a further collision load, a portion of the radiator 30 on the vehicle upper side crushes the accommodating portion 60, so that a part of the collision load can be absorbed.

In the above-described embodiment, the accommodating portion 60 is separated from the hood 28, but the present disclosure is not limited thereto, and may be provided on the back surface of the hood 28. In this case, the accommodating portion 60 may be configured as a cable accommodating portion that houses a charging cable (not shown) for supplying electric power from an external power source to the vehicle 12.

### Supplementary Explanation

In the first embodiment and the second embodiment, the cross member 26 is a lower absorber, but the present disclosure is not limited thereto, and any member may be used as long as the member is pushed when a collision load from the front is applied. Further, the fixing portion 50 may be fixed to the vehicle body 11 other than the cross member 26 by using, for example, a bracket or the like without fixing the radiator 30 to the cross member 26. In this case, the vehicle body 11 used for fixing is a member that is pushed when a collision load from the front is applied.

Further, in the above-described embodiment, the radiator has been described as an example of the heat exchanger, but the heat exchanger of the present disclosure is not limited to the radiator. The heat exchanger may be, for example, a condenser, a heat exchanger for air conditioning of a vehicle, or the like.

Further, the configuration of the present disclosure is not limited to the above-described embodiment, and the configuration can be changed as appropriate as long as the problem can be solved.

What is claimed is:

1. A vehicle front part structure comprising:
a pair of front side members that extend along a vehicle front-rear direction on both sides of a vehicle front part in a vehicle width direction;
a heat exchanger that is disposed between the pair of front side members, the heat exchanger being disposed in an inclined posture in which an end portion on a vehicle lower side projects closer to a vehicle front side than an end portion on a vehicle upper side;
support portions each provided at an intermediate portion of the pair of front side members in the vehicle front-rear direction and on a vehicle rear side of the heat exchanger, the support portions supporting the heat exchanger such that the heat exchanger is rotatable about the vehicle width direction as an axial direction; and
a fixing portion that fixes a portion of the heat exchanger on the vehicle lower side to a vehicle body.

2. The vehicle front part structure according to claim 1, wherein the fixing portion includes a protruding portion that projects from a side of the vehicle body and a fitting recessed portion that is provided on a side of the heat exchanger, the protruding portion being fitted into the fitting recessed portion.

3. The vehicle front part structure according to claim 2, wherein the fixing portion further includes an elastic portion that is interposed between the protruding portion and the fitting recessed portion.

4. The vehicle front part structure according to claim 1, wherein a portion of the heat exchanger on the vehicle lower side is fixed to a lower absorber that extends in the vehicle width direction as the vehicle body, and at least a part of a side surface of the lower absorber on the vehicle front side is disposed closer to the vehicle front side than the pair of front side members.

5. The vehicle front part structure according to claim 1, wherein the support portions are configured to support an end portion of the heat exchanger on the vehicle upper side.

6. The vehicle front part structure according to claim 1, further comprising:
a hood that covers a power unit room at the vehicle front part from the vehicle upper side; and
an accommodating portion with a box shape that is provided on the vehicle upper side of the heat exchanger and on the vehicle lower side of the hood, wherein
the support portions are configured to support an intermediate portion of the heat exchanger in a vehicle up-down direction, and
the heat exchanger is configured such that once the heat exchanger rotates in response to release of fixation achieved by the fixing portion, a portion of the heat exchanger on the vehicle upper side abuts the accommodating portion.
